(19) United States
(12) Patent Application Publication
(10) Pub. No.: US 2015/0288219 A1
(43) Pub. Date: Oct. 8, 2015

(54) Portable Power Bank

(71) Applicant: LausDeo Corporation, Yangmei City (TW)

(72) Inventors: MING-CHIEH LIN, Taichung City (TW); CHUN-LIANG YANG, Taichung City (TW); WEN-HSIANG CHANG, Taichung City (TW); JUNG KUO, Taichung City (TW); MENG-KWEI HSU, Taichung City (TW)

(21) Appl. No.: 14/321,767

(22) Filed: Jul. 1, 2014

(30) Foreign Application Priority Data
Apr. 3, 2014 (TW) 103112439

(51) Int. Cl. H02J 7/04; H02J 7/00

(52) U.S. Cl. CPC H02J 7/04; H02J 7/0013

(57) ABSTRACT

The present invention relates to a portable power bank comprising a battery pack, a first control module and a second control module, wherein the battery pack further comprises at least two cells connected in series, and wherein the first control module and the second control module both electrically connected to a first terminal and a second terminal of the battery pack; the first controller is configured for regulating the DC input voltage for charging the battery pack and the second controller is configured for regulating the DC output voltage for charging an external device.

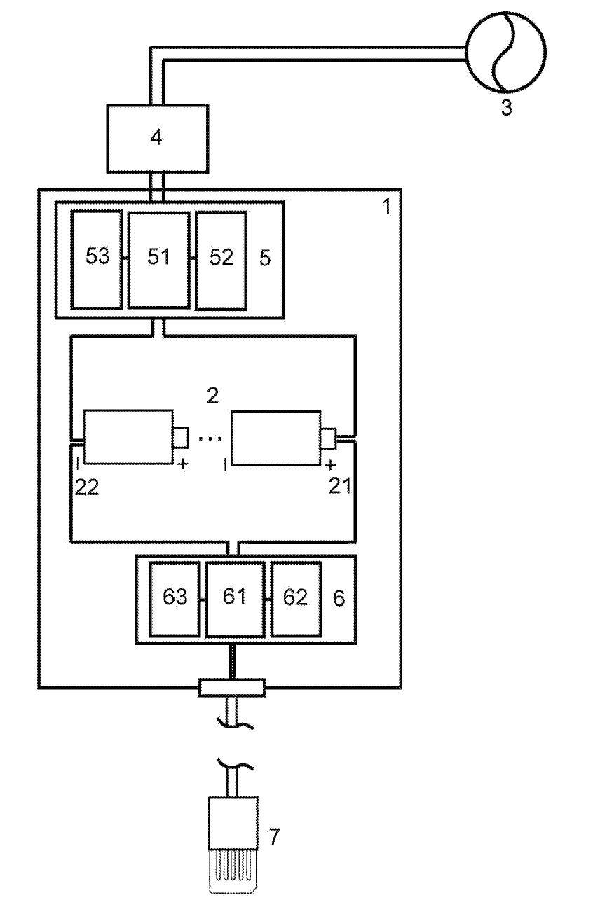

### TECHNICAL FIELD

At least one embodiment in accordance with the present invention relates to a portable power bank. More particularly, at least one embodiment relates to a portable power bank characterized by a rapid charging rate.

### DESCRIPTION OF THE RELATED ART

A power bank is configured for supplying electric energy to electronic devices. In recent years, electronic devices such as cell phones and tablets have induced a massive transformation in the lifestyles nowadays. With the growing dependence on these electronic devices, the demand for high capacity batteries has increased for supporting a full day's use; however, to elevate the capacity of a battery may simultaneously augment the weight and the physical volume. In this case, a backup battery may be a solution; nevertheless, the current fashion tenting to use embedded batteries instead of removable batteries subsequently stimulates the development of power banks as an alternative method.

Conventional power banks comprise multiple battery cells connected in parallel to increase the capacity. However, upon charging a power bank, the electric charge flow required for charging may be significantly increased with the number of battery cells connected in the power bank. According to Kirchhoff Circuit Laws, the sum of currents flowing through the battery cells connected in parallel is equal to the current flowing out from a power source charging the power bank. No matter the power source is providing a direct current (DC) or an alternative current (AC), more the battery cells are connected together in a power bank, higher the current are being outputted from a power source. Large quantities of energy lost and heat generated during energy transfer are inevitable in conventional power banks; the number of battery cells chained in conventional power banks is therefore being limited to avoid the risk of electrical fires.

In addition, battery cells connected in parallel provides the same voltage as a single battery cell. Once the charging current flowing out from the power bank is also invariable, the constant voltage of a power bank may lead to a problem that the charging rate is low for some electronic devices.

Another concern of conventional power banks is the battery types used within. Battery cells commonly seen in conventional power banks usually are NiMH batteries or NiCd batteries. These types of batteries comprise several defects such as severe memory effect, toxin materials, and short battery life.

Accordingly, there is a need for a novel design for power banks to provide advantages including high charging rate, long battery life, and safe to use.

### SUMMARY

At least one embodiment in accordance with the present invention relates to a portable power bank comprising a battery pack, a first control module and a second control module, wherein the battery pack includes at least two lithium-ion cells electrically connected in series.

Batteries in power banks usually are charged with external power supplies, wherein most of those external power supplies provide AC currents which were converted into DC currents before being supplied to the batteries. The AC/DC conversion protects electronic components contained in a power bank from damages, and the AD/DC conversion also largely improves the safety and the efficiency of energy transfer therein.

In some embodiments of the present invention, an electric charge flow provided by an external power supply is converted to a charging current by a rectifier; the charging current is then transferred to a first control module electrically connected with the rectifier, wherein the first control module comprises a first microcontroller, and wherein the first microcontroller includes a first pre-determined voltage range; the charging current is then converted, by the first control module, to a DC input voltage in accordance with the first pre-determined voltage range to charge the at least two lithium-ion cells, wherein the DC input voltage is stored by the at least two lithium-ion cells as a battery energy. In some aspects, once the DC input voltage exceeds the first pre-determined voltage range, the first microcontroller will send a signal to the first buck transformer to regulate the DC input voltage. In some other aspects, once voltage of the DC input voltage is below the minimum of the first voltage range, the first microcontroller will send a signal to the first boost transformer to regulate the DC input voltage.

In some other embodiments, the cell in the at least two lithium-ion cells is a battery selected from the group consisting of a LiFePO4 battery, a LiNiO2 battery, a Li(NiMnCo)O2 battery and a LiCoO2 battery. In a preferable embodiment, the cells in the at least two lithium-ion cells are all the same type of battery. Since the at least two lithium-ion cells electrically connected in series share the same electric charge flow, the DC input voltage is able to be higher than conventional power banks in some embodiments; therefore, the DC input voltage is capable of charging the at least two lithium-ion cells with a rapid charging rate.

In yet some other embodiments, the at least two lithium-ion cells output the battery energy to the second control module electronically connected to the battery pack, wherein the second control module includes a second microcontroller, and wherein the second microcontroller includes a second pre-determined voltage range. In some aspects, the second microcontroller will determine the DC output voltage in accordance with the second pre-determined voltage range once the external device is connected. In some other aspects, the connected external device may be one selected from the group consisting of a cell phone, a tablet, a laptop, and an electric bike, wherein the voltages required for charging these external devices are largely varied; therefore, the second microcontroller determines the DC output voltage in accordance with both the second pre-determined voltage and the external device connected with.

In still yet some other embodiments, once the DC output voltage exceeds the second pre-determined second voltage range, the second microcontroller will send a signal to the second buck transformer to regulate the DC output voltage; once the DC output voltage does not reach the minimum of the second voltage range, the second microcontroller will send a signal to the second boost transformer to regulate the DC output voltage.

At least one embodiments in accordance with the present invention relates to a portable power bank comprises at least two lithium-ion cells electrically connected in series and therefore overcome the defects in conventional power bank, such as heavy load in electric charge flow, slow charging rate, and voltage instability.

### BRIEF DESCRIPTION OF THE DRAWINGS

The FIGURE is a schematic diagram illustrating a portable power bank in accordance with at least one embodiment of the present invention

### DESCRIPTION OF THE PREFERRED EMBODIMENTS

In a general aspect, at least one embodiment in accordance with the present invention relates to a portable power bank. More particularly, at least one embodiment relates to a portable power bank characterized by a high charging rate. The embodiments and drawings provided here show different aspects of the present invention. However, the present invention are neither limited to any embodiment nor drawing thereof.

The FIGURE is a schematic diagram illustrating a portable power bank in accordance with at least one embodiment of the present invention. In the FIGURE, an AC power source 3 provides AC currents to a rectifier 4, and the rectifier 4 converts the AC currents into charging currents and transfers the charging currents to a portable power bank 1, wherein the charging currents are DC currents.

In some embodiments of the FIGURE, the portable power bank 1 comprises a first control module 5, connected to the rectifier 4, for receiving the charging currents; the first control module 5 further includes a first microcontroller 51 for detecting voltage of the charging currents. In some other aspects of the aforementioned embodiments, after the voltage of the charging currents were being detected, the control module 5 converts the charging currents to a DC input voltage ranging from 12 to 19 volts in accordance with a first pre-determined voltage range pre-defined in the first control module 5.

In some embodiments of the FIGURE, the portable power bank 1 further comprises a battery pack 2, electrically connected to the first control module 5, for storing power from the DC input voltage as a battery energy; the battery pack 2 includes at least two lithium-ion cells electrically connected in series, wherein the cell in the at least two lithium-ion cells is a battery selected from the group consisting of a LiFePO4 battery, a LiNiO2 battery, a Li(NiMnCo)O2 battery and a LiCoO2 battery. In some aspects of the aforementioned embodiments, cells in the at least two lithium-ion cells are the same type of battery and are electrically connected in series. In some other aspects of the aforementioned embodiments, cells in the at least two lithium-ion cells are all LiFePO4 batteries. A LiFePO4 battery is able to withstand 2000 charge/discharge cycles—a number four times higher than a Li(NiMnCo)O2 battery and a LiCoO2 battery.

In some embodiments of the FIGURE, the first microcontroller 51 is configured for detecting that whether voltage of the charging currents falls into the range of 12 to 19 volts. In some other aspects of the aforementioned embodiments, once voltage of the charging currents is below 12 volts, the first microcontroller 51 will deliver a signal via a MOSFET (not shown) to activate a first boost transformer 52; the first boost transformer 52, then, elevates the voltage of the charging currents to a value between 12 and 19 volts, wherein the value is higher than the electric potential difference between a first terminal 21 and a second terminal 22 of the battery pack 2. In some other aspects of the aforementioned embodiments, once voltage of the charging currents is above 19 volts, the first microcontroller 51 will deliver a signal via a MOSFET (not shown) to activated a first buck transformer 53; the first buck transformer, then, steps down the voltage of the charging currents to a value between 12 and 19 volts, wherein the value is higher than the electric potential difference between the first terminal 21 and the second terminal 22. In yet some other aspects of the aforementioned embodiments, each cell in the at least two lithium-ion cells provides a voltage in the range of 3.2 to 4.3 volt and the electric potential difference between the first terminal 21 and the second terminal 22 is determined based on the number of cells connected in series in the battery pack 2.

In some embodiments of the FIGURE, an external device is connected to the portable power bank 1 via a connector 7, wherein the connector 7 is a USB connector or one of the connectors known in the art, and wherein the connector 7 is dis-connectable; once the external device is connected with the portable power bank 1, the battery pack 2 will output the battery energy therein to charge the external device.

In some embodiments of the FIGURE, the portable power bank 1 further comprises a second control module 6, connected to the battery pack 2 and the external device, for converting the outputted battery energy to a DC output voltage. In some aspects of the aforementioned embodiments, a second microcontroller 61 in the second control module 6 determines a proper value of the DC output voltage based on the second voltage range pre-defined in the second control module 6, wherein the second voltage range is above 3 volts, and wherein the DC output voltage is in a range of 5 to 19 volts. In some other aspects of the aforementioned embodiments, the second microcontroller 61 detects that whether voltage of the outputted battery power falls into the range of 5 to 19 volts; once voltage of the outputted battery energy is below 5 volts, the second microcontroller 61 will deliver a signal via a MOSFET (not shown) to activate a second boost transformer 62; the second boost transformer 62, then, elevates the DC output voltage to a value between 5 and 19 volts. In yet some other aspects of the aforementioned embodiments, once voltage of the outputted battery energy exceeds 19 volts, the second microcontroller 61 will deliver a signal via a MOSFET (not shown) to activate a second buck transformer 63; the second buck transformer 63, then, steps down the DC output voltage to a value between 5 to 19 volts. In still yet some other aspects of the aforementioned embodiments, the DC output voltage is in a range of 3 to 5 A.

What is claimed is:

1. A portable power bank comprising:
a battery pack, wherein the battery pack comprises at least two lithium-ion cells electrically connected in series;
a first control module, electrically connected to a first terminal and a second terminal of the battery pack, for converting a charging current to a DC input voltage in a first pre-determined voltage range and supplying the DC input voltage to the battery pack, wherein the battery pack stores the DC input voltage as a battery power, and wherein the first control module includes:
a first microcontroller;
a first boost transformer electrically connected to the first microcontroller; and
a first buck transformer electrically connected to the first microcontroller; and
a second control module, electrically connected to the first terminal and the second terminal of the battery pack, for converting the battery power being outputted from the battery pack to a DC output voltage and supplying the DC output voltage to an external device, wherein the DC output voltage is a constant current in a second pre-determined voltage range, and wherein the second control module includes:
a second microcontroller;
a second boost transformer electrically connected to the second microcontroller; and
a second buck transformer electrically connected to the second microcontroller.

2. The portable power bank according to claim 1, wherein the cell in the at least two lithium-ion cells is one selected from the group consisting of a LiFePO4 battery, a LiNiO2 battery, a Li(NiMnCo)O2 battery and a LiCoO2 battery.

3. The portable power bank according to claim 1, wherein each cell in the at least two lithium-ion cells provides a voltage in a range of 3.2 to 4.3 volts.

4. The portable power bank according to claim 1, wherein the first pre-determined voltage range is between 12 and 19 volts.

5. The portable power bank according to claim 1, wherein voltage of the charging current is in a range of 12 to 19 volts.

6. The portable power bank according to claim 1, wherein the second pre-determined voltage range is above 3 volts.

7. The portable power bank according to claim 1, wherein the DC output voltage is in a range of 5 to 19 volts.

8. The portable power bank according to claim 1, wherein the DC output voltage is in a range of 3 to 5 A.
